(19) United States
(12) Patent Application Publication
(10) Pub. No.: US 2014/0288948 A1
(43) Pub. Date: Sep. 25, 2014

(54) METHODS, SYSTEMS, AND COMPUTER PROGRAM PRODUCTS FOR MANAGING THE TRANSFER OF VALUE BETWEEN A HEALTH CARE BUSINESS ENTITY AND A HEALTH CARE PROFESSIONAL

(71) Applicant: AGGREGATE SPEND SOLUTIONS, LLC, Raleigh, NC (US)

(72) Inventors: John W. Lewis, JR., Wendell, NC (US); Theresa L. Jeffries, Raleigh, NC (US); Ted J. Wright, Raleigh, NC (US); John Lewis, III, Cary, NC (US); Jason M. Lewis, Raleigh, NC (US); Aprel H. Buonpane, Raleigh, NC (US); Eddie A. Albertson, Raleigh, NC (US)

(73) Assignee: AGGREGATE SPEND SOLUTIONS, LLC, Raleigh, NC (US)

(21) Appl. No.: 14/219,722

(22) Filed: Mar. 19, 2014

Related U.S. Application Data
(60) Provisional application No. 61/803,243, filed on Mar. 19, 2013.
(60) Provisional application No. 61/897,044, filed on Oct. 29, 2013.

(51) Int. Cl. G06Q 50/22; G06Q 30/00

(52) U.S. Cl. CPC G06Q 50/22; G06Q 30/018
USPC 705/2

(57) ABSTRACT

A method includes performing operations as follows on at least one processor: associating a health care professional (HCP) with an event, the event comprising a transaction involving a transfer of value from an entity to the HCP, electronically generating a recordation of an acceptance of the transfer of value by the HCP during the transaction, and saving the recordation of the acceptance of the transfer of value in a data repository.

### CROSS REFERENCE TO RELATED APPLICATIONS

This application claims the benefit of U.S. Provisional Application No. 61/803,243 filed Mar. 19, 2013 and U.S. Provisional Application No. 61/897,044 filed Oct. 29, 2013, the disclosures of which are hereby incorporated herein by reference

### BACKGROUND

The present disclosure relates to retailing methods, systems, and computer program products for data/information collection and reporting for purposes of regulatory compliance and, more particularly, to methods, systems, and computer program products for data/information collection and reporting related to the transfer of value from an entity to a health care professional.

The Physicians Payments Sunshine Provisions (“PPSA”), also referred to as “Open Payments” is a part of the Patient Protection and Affordable Care Act of 2009 and requires all drug, medical device, biologics, and medical supply manufacturers operating in the United States (U.S.) whose products are covered by federally backed medical insurance—such as Medicare, Medicaid, or the State Children's Health Insurance Program (SCHIP) to report to the U.S. Department of Health & Human Services (DHHS) all payments made—including meeting expenses—to doctors and teaching hospitals. These doctors and teaching hospitals may be called “covered recipients and/or Health Care Professionals (HCP)”. The DHHS intends to make such information available to the public for viewing and searching. The Center for Medicare and Medicaid Services (CMS) is responsible for providing guidance and governance to the health care industry to assist those in the industry in complying with the PPSA laws and regulations. The PPSA is the first nationally-mandated set of laws and regulations to address payment and gifts provided to HCPs. These laws/regulations may supplement or override any existing laws/regulations that currently exist in various states in the U.S.

Conventional techniques for complying with laws/regulations regarding payments and gifts provided to HCPs typically involve the manual process of having an HCP register on a sign-in sheet when attending a meeting or dinner, for example. An HCP may also send paper receipts to a health care business entity that is providing something of value to the HCP. For example, an HCP may send in an expense report for meals, travel, lodging, etc. to a business entity that is sponsoring a convention for HCPs. The business entity may then have to manually compile the information provided from the HCPs to be submitted in a report to the appropriate governmental authority. Such a manual compilation, however, may be prone to mistakes and, if the paperwork showing the transfer of value becomes corrupted, e.g., a sign-in sheet is damaged, it may not be able to be used as evidence of the transfer of value from the business entity to the HCP.

### SUMMARY

In some embodiments of the inventive subject matter, a method comprises performing operations as follows on at least one processor: associating a health care professional (HCP) with an event, the event comprising a transaction involving a transfer of value from an entity to the HCP, electronically generating a recordation of an acceptance of the transfer of value by the HCP during the transaction, and saving the recordation of the acceptance of the transfer of value in a data repository.

In other embodiments, electronically generating the recordation of the acceptance comprises scanning a code that identifies the HCP.

In still other embodiments, the code is a barcode.

In still other embodiments, the code is a Quick Response (QR) code.

In still other embodiments, electronically generating the recordation of the acceptance comprises detecting a mobile device associated with the HCP using a near field communication (NFC) connection.

In still other embodiments, electronically generating the recordation of the acceptance comprises detecting a radio frequency identification (RFID) tag associated with the HCP using an RFID tag reader.

In still other embodiments, saving the recordation of the acceptance of the transfer of value comprises formatting the recordation of the acceptance of the transfer of value into a report that is compliant with a formatting standard established by a governmental regulatory agency.

In still other embodiments, the method further comprises notifying the HCP of the recordation of the acceptance of the transfer of value.

In still other embodiments, the method further comprises receiving a confirmation from the HCP that the recordation of the acceptance of the transfer of value is accurate, formatting the recordation of the acceptance of the transfer of value into a report that is compliant with a formatting standard established by a governmental regulatory agency, and submitting the report to the entity and/or the governmental regulatory agency.

In still other embodiments, the method further comprises receiving a dispute notification from the HCP indicating that the recordation of the acceptance of the transfer of value is inaccurate and notifying the entity that the HCP is disputing the accuracy of the recordation of the acceptance of the transfer of value.

In still other embodiments, the method further comprises formatting the recordation of the acceptance of the transfer of value into a report that is compliant with a formatting standard established by a governmental regulatory agency and submitting the report to the entity and/or the governmental regulatory agency when no response is received from the HCP disputing the recordation of the acceptance of the transfer of value within a defined time period.

In still other embodiments, saving the recordation of the acceptance of the transfer of value comprises aggregating the recordation of the acceptance of the transfer of value with recordations of a plurality of transactions involving transfers of value from the entity to the HCP. The method further comprises formatting the recordations that have been aggregated into a report that is compliant with a formatting standard established by a governmental regulatory agency and submitting the report to the entity and/or the governmental regulatory agency.

In still other embodiments, saving the recordation of the acceptance of the transfer of value comprises transmitting the recordation of the acceptance of value to the data repository in real time.

Other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims Moreover, it is intended that all embodiments disclosed herein can be implemented separately or combined in any way and/or combination.

### BRIEF DESCRIPTION OF THE DRAWINGS

Other features of exemplary embodiments will be more readily understood from the following detailed description of specific embodiments thereof when read in conjunction with the accompanying drawings, in which:

FIG. 1 is a block diagram that illustrates a cloud computing paradigm;

FIG. 2 is a block diagram that illustrates a virtualized computing environment;

FIG. 3 is a block diagram that illustrates a cloud computing environment;

FIG. 4 is a block diagram that illustrates a system for managing the transfer of value between a health care business entity and a healthcare professional according to some embodiments of the inventive subject matter;

FIG. 5 is a block diagram that illustrates a data processing system that may be used in embodiments of the payment aggregation system of FIG. 4 in accordance with some embodiments of the inventive subject matter;

FIG. 6 is a block diagram that illustrates a software/hardware architecture for a payment aggregation system server in accordance with some embodiments of the inventive subject matter;

FIG. 7 illustrates a user interface through which a health care business entity may provide various identifying information according to some embodiments of the inventive subject matter;

FIG. 8 illustrates a user interface for uploading data from a health care business entity for an event according to some embodiments of the inventive subject matter;

FIG. 9 illustrates a user interface for defining transaction opportunities for transferring value to a healthcare professional according to some embodiments of the inventive subject matter;

FIG. 10 illustrates a report that is formatted according to a format prescribed by the Center for Medicare/Medicaid Services to communicate transfer of value information between a health care business entity and a healthcare professional according to some embodiments of the inventive subject matter;

FIGS. 11-12 are flowcharts that illustrate operations for managing the transfer of value between a health care business entity and a healthcare professional according to some embodiments of the inventive subject matter;

FIG. 13 illustrates a user interface for manual entry of transfer of value information according to some embodiments of the inventive subject matter;

FIG. 14 illustrates a user interface for reviewing transfer of value information for healthcare professional attendees to a meeting according to some embodiments of the inventive subject matter; and

FIG. 15 illustrates a user interface for reviewing the transfer of value entries for a particular healthcare professional for a particular meeting according to some embodiments of the inventive subject matter.

### DETAILED DESCRIPTION

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Peri, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Embodiments of the inventive subject matter are described herein with respect to computing resources being provided by a computing resource provider. As used herein, a computing resource may include, but is not limited to, a virtual machine, a computer processor, a data storage element, such as a memory, a database, a communication medium, a switch, a router, a data center, a host processor/system, a cluster, an application, a hypervisor, a host operating system, a guest operating system, and the like. It will be further understood that a computing resource may include portions of the aforementioned elements, for example. In this regard, a computing resource may comprise a time slice of a virtual machine or processor, a particular bandwidth of a communication medium, a portion of a memory, and/or a portion of a database.

As used herein, the term “mobile device” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. A mobile device may also include a frequency modulated (FM), amplitude modulated (AM), and/or satellite radio receiver for receiving radio transmissions. Mobile devices may also be referred to as “pervasive computing” devices.

Some embodiments are described herein in the context of providing computing or data processing services via the cloud. Cloud computing is a computing paradigm where shared resources, such as processor(s), software, and information, are provided to computers and other devices on demand typically over a network, such as the Internet. In a cloud computing environment, details of the computing infrastructure, e.g., processing power, data storage, bandwidth, and/or other resources are abstracted from the user. The user does not need to have any expertise in or control over such computing infrastructure resources. Cloud computing typically involves the provision of dynamically scalable and/or virtualized resources over the Internet. A user may access and use such resources through the use of a Web browser. A typical cloud computing provider may provide an online application that can be accessed over the Internet using a browser. The cloud computing provider, however, maintains the software for the application and some or all of the data associated with the application on servers in the cloud, i.e., servers that are maintained by the cloud computing provider rather than the users of the application.

As used herein, “health care professional” (HCP) means any person and/or entity for whom reporting to a governmental regulatory agency is required when the person or entity receives a transfer of value from an entity whose products and/or services are regulated by a governmental regulatory agency. For example, the Physicians Payments Sunshine Provisions (“PPSA”), which is also known as Open Payments, are a part of the Patient Protection and Affordable Care Act of 2009 and require the reporting of transactions involving the transfer of value from entities whose products and/or services are covered by federally backed medical insurance to entities, such as doctors, and teaching hospitals, to the US Department of Health & Human Services.

As used herein, “data” means raw, unorganized facts that need to be processed. Data can be something simple and seemingly random and useless until it is organized. When data is processed, organized, structured, or presented in a given context so as to make it useful it is called “information.”

As used herein, the term “data processing facility” includes, but it not limited to, a hardware element, firmware component, and/or software component. A data processing system may be configured with one or more data processing facilities.

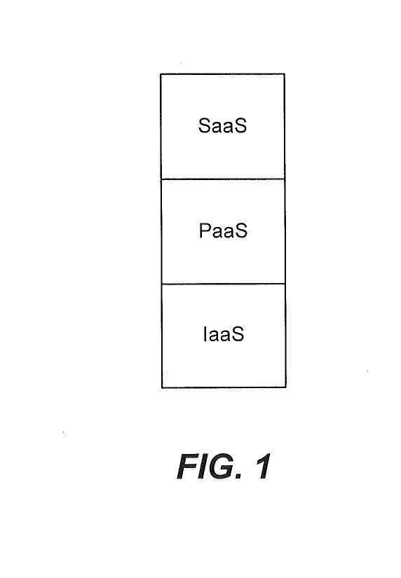

FIG. 1 illustrates a conventional cloud service model that includes Infrastructure as a Service (IaaS), Platform as a Service (PaaS), and Software as a Service (SaaS). Infrastructure as a Service, delivers computer infrastructure—typically a platform virtualization environment—as a service. Rather than purchasing servers, software, data-center space or network equipment, clients instead buy those resources as a fully outsourced service. Suppliers typically bill such services on a utility computing basis and the amount of resources consumed. Platform as a Service delivers a computing platform as a service. It provides an environment for the deployment of applications without the need for a client to buy and manage the underlying hardware and software layers. Software as a Service delivers software services over the Internet, which reduces or eliminates the need for the client to install and run an application on its own computers, which may simplify maintenance and support.

Virtualized computing environments may be used to provide computing resources to end users. In a cloud computing environment, the physical hardware configuration is hidden from the end user. Cloud computing systems may include servers, network storage devices, routers, gateways, communication links, and other devices. Because the physical hardware and software platforms on which cloud computing system is implemented are hidden within a “cloud,” they can be managed, upgraded, replaced or otherwise changed by a system administrator without the customer being aware of or affected by the change.

In a typical cloud computing environment, applications may be executed on virtual machines, which are isolated guest operating systems installed within a host system. Virtual machines are typically implemented with either software emulation or hardware virtualization, or both. A single hardware and/or software platform may host a number of virtual machines, each of which may have access to some portion of the platform's resources, such as processing resources, storage resources, etc.

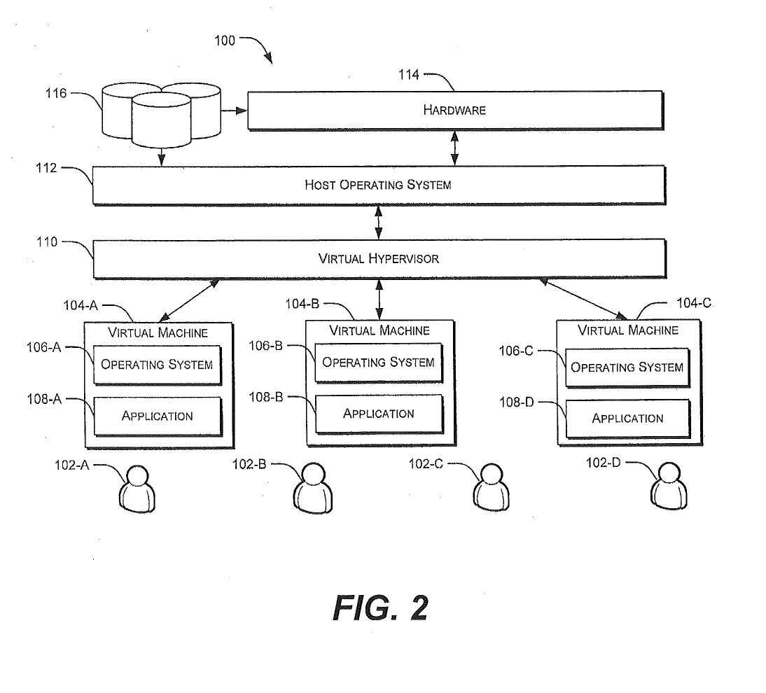

FIG. 2 illustrates a server system 100 for a virtualized computing environment in which the inventive subject matter of the present disclosure can function. The server system 100 generally hosts one or more virtual machines 104 (hereafter virtual machine 104), each of which runs a guest operating system 106 and application 108. The computing needs of users 102 drive the functionality of the virtual machines 104. A hypervisor 110 provides an interface between the virtual machines 104 and a host operating system 112 and allows multiple guest operating systems 106 and associated applications 108 to run concurrently. The host operating system 112 handles the operations of a hardware platform 114 capable of implementing virtual machines 104. A data storage space 116 may be accessed by the host operating system 112 and is connected to the hardware platform 114.

The hardware platform 114 generally refers to any computing system capable of implementing virtual machines 104, which may include, without limitation, a mainframe, personal computer (PC), micro-computer, handheld computer, mobile computing platform, server, or any other appropriate computer hardware. The hardware platform 114 may include computing resources, such as a central processing unit (CPU); networking controllers; communication controllers; a display unit; a program and data storage device; memory controllers; input devices (e.g., a keyboard, a mouse, etc.) and output devices, such as printers. The CPU may be any processor capable of supporting virtualization.

The hardware platform 114 may be further connected to the data storage space 116 through serial or parallel connections. The data storage space 116 may be any suitable device capable of storing computer-readable data and instructions, and it may include logic in the form of software applications, random access memory (RAM), or read only memory (ROM), removable media, or any other suitable memory component. According to the illustrated embodiment, the host operating system 112 stands between the hardware platform 114 and the users 102 and is responsible for the management and coordination of activities and the sharing of the computing resources. Although some embodiments of the computer system 100 can be configured to operate as a computer server, the computer system 100 is not limited thereto and can be configured to provide other functionality, such as data processing, communications routing, etc.

Besides acting as a host for computing applications that run on the hardware platform 114, the host operating system 112 may operate at the highest priority level in the server 100, executing instructions associated with the hardware platform 114, and it may have exclusive privileged access to the hardware platform 114. The priority and privileged access of hardware resources affords the host operating system 112 exclusive control over resources and instructions, and may preclude interference with the execution of different application programs. The hypervisor 110 creates an environment for implementing a virtual machine, hosting the “guest” virtual machine. One host operating system 112 is capable of implementing multiple isolated virtual machines simultaneously.

A hypervisor 110 (which may also be known as a machine monitor or VMM) runs on the host operating system 112 and provides an interface between the virtual machines 104 and the hardware platform 114 through the host operating system 112. The hypervisor 110 virtualizes the computing system resources and facilitates the operation of the virtual machines 104. The hypervisor 110 may provide the illusion of operating at the highest priority level to the guest operating systems 106. The hypervisor 110 maps the guest operating system's priority level to a priority level lower than the top most priority level. As a result, the hypervisor 110 can intercept the guest operating system 106 to execute instructions that require virtualization assistance. Alternatively, the hypervisor 110 may emulate or actually execute the instructions on behalf of the guest operating system 106. Software operations permitting indirect interaction between the guest operating system 106 and the physical hardware platform 114 are also performed by the hypervisor 110.

Virtual machines 104 present a virtualized environment to guest operating systems 106, which in turn provide an operating environment for applications 108 and other software constructs.

The foregoing description with respect to FIG. 2 of a virtualized computing environment uses a Type 2 or hosted hypervisor 110, which runs within a conventional operating system environment. In this configuration, the hypervisor layer is disposed between the host operating system and one or more guest operating systems. It will be understood that the hypervisor can also be implemented as a Type 1 hypervisor, which may be called a native or bare metal hypervisor. A Type 1 hypervisor runs directly on the host's hardware to control the hardware and manage guest operating systems. Thus, a Type 1 hypervisor layer is disposed between the hardware and one or more guest operating systems. In accordance with various embodiments of the present inventive concept, a Type 1 or a Type 2 hypervisor can be used to implement a virtualized computing environment.

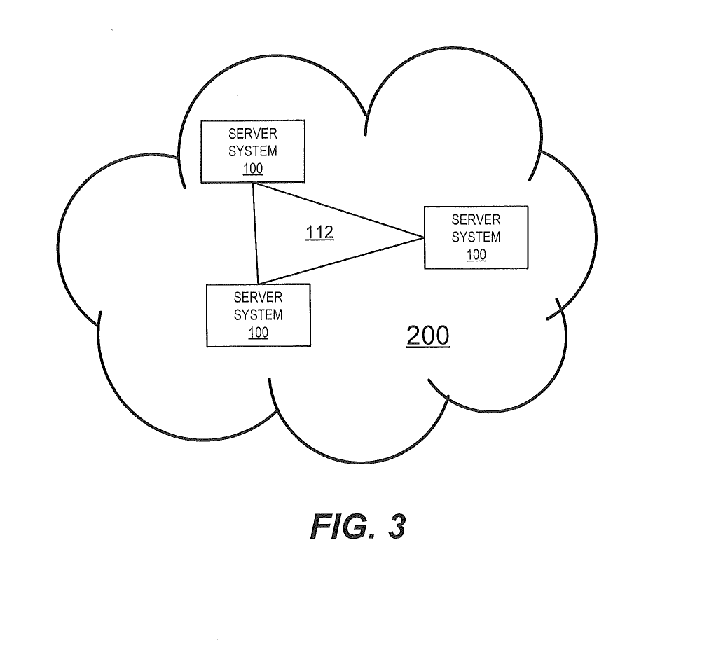

Referring to FIG. 3, a virtualized computing environment 200 (referred to generally as cloud 200) may include one or more server systems 100 that may include one or more electronic computing devices operable to receive, transmit, process, and store data. For example, the servers in the cloud 200 may include one or more general-purpose PCs, Macintoshes, micro-computers, workstations, Unix-based computers, server computers, one or more server pools, or any other suitable devices. In certain embodiments, the cloud 200 may include a web server. In short, the cloud 200 may include any suitable combination of software, firmware, and hardware.

The cloud 200 may include a plurality of server systems 100 that are communicatively coupled via a network 112. The network 112 facilitates wireless or wireline communication, and may communicate using, for example, IP packets, Frame Relay frames, Asynchronous Transfer Mode (ATM) cells, voice, video, data, and other suitable information between network addresses. The network 112 may include one or more local area networks (LANs), radio access networks (RANs), metropolitan area networks (MANS), wide area networks (WANs), all or a portion of the global computer network known as the Internet, and/or any other communication system or systems at one or more locations. Although referred to herein as “server systems,” it will be appreciated that any suitable computing device may be used.

Virtual machines and/or other objects in a virtualization environment can be grouped into logical clusters for management and/or operational purposes. For example, virtual machines can be grouped into clusters based on load balancing needs, security needs, redundancy needs, or any other needs as determined by a system administrator. The virtual machines grouped within a cluster may or may not all be implemented on a single physical server. Any desired number of clusters can be defined subject to system limitations, and each of the clusters can include any desired number of virtual machines subject to server limitations.

Virtual machines can be deployed in particular virtualization environments and organized to increase the efficiency of operating and/or managing a virtual computing environment. For example, virtual machines may be grouped into clusters to provide load balancing across multiple servers.

Virtual machines within a same cluster can be managed by a single virtualization environment manager to have the same or similar resource access privileges (e.g., processor utilization, priority, memory allocation, communication interface access privileges, etc.), while virtual machines within different clusters can have different resource access privileges.

Virtual machines that are deployed within a single cluster may share physical resources within a server. For example, virtual machines that are deployed within a single cluster may share physical memory, storage, communication facilities and other resources or services of a server. Whenever computing resources are shared, there is the possibility that one virtual machine could intentionally or unintentionally gain access to data of another virtual machine.

Some embodiments of the inventive subject matter stem from a realization that it may be difficult for health care business entities, such as drug companies, medical device companies, biotech companies, medical supply companies, Group Purchasing Organizations (GPOs) and the like to track all payments to Healthcare Professionals (HCPs) so that they can be reported to the U.S. Department of Health & Human Services (DHHS) to comply with the Physician Payment Sunshine Provisions (PPSA), which is also known as Open Payments. Payments or expenditures, which may be referred to as “transfer of value” to HCPs may be categorized as direct or indirect. Direct expenditures typically involve direct cash transactions, such as, but not limited to, consulting fees, honoraria expenses, gift expenses, entertainment expenses, research expenses, charitable contributions, royalty or license expenses, ownership/investment expenses, interest expenses, speaker fees, and grants. Indirect expenditures typically do not involve a direct cash payment to an HCP, but, nevertheless, still constitute a transfer of value to the HCP. Examples of indirect expenditures include, but are not limited to, the coverage of such expenses as lodging expenses, entertainment expenses, education expenses, honoraria expenses, travel expenses, food/beverage expenses, promotional expenses, meeting planning expenses, and service expenses. Indirect expenditures may be more difficult to track and report as they frequently involve a third party provider, or, if managed internally by a health care business entity, may be difficult to assign an exact dollar amount to a particular HCP.

Embodiments of the present inventive subject may allow a health care business entity to associate an HCP with an event, which comprises one or more transactions involving a transfer of value from the health care business entity to the HCP. For example, the event may be a conference that includes various transaction opportunities, such as meals, gifts, lodging expenses, entertainment expenses, which an HCP attendee may accept to receive a transfer of value from the health care business entity. When the HCP accepts a transaction involving a transfer of value from the health care business entity, a recordation of the acceptance can be electronically generated. For example, when the transaction is a dinner provided to the HCP, the HCP may carry some type of code, such as a barcode or Quick Response (QR) code, which provides an identification, which can then be scanned upon entry to the dining room. The HCP is, therefore, identified as having accepted a transfer of value corresponding to the value of a meal. This recordation of having accepted the transfer of value can be saved and aggregated with other transactions in which the HCP accepts the transfer of value from the health care business entity. These transactions may involve the acceptance of value in the form of direct and/or indirect expenditures as described above. The various transactions in which value has been transferred to the HCP can be communicated to the HCP to provide the HCP with an opportunity to dispute the transactions or confirm the transactions before the transactions are reported to a governmental regulatory agency, such as the DHHS. By electronically generating the acceptance by the HCP of transactions involving the transfer of value to the HCP, a health care business entity may better comply with government regulatory reporting requirements by improving the accuracy and completeness of the transfer of value transaction information reported for HCPs as compared to compiling such information manually and/or through polling various sources, such as the HCPs, the entities employing the HCPs, third party providers, such as transportation providers, lodging providers, food/beverage providers, and the like.

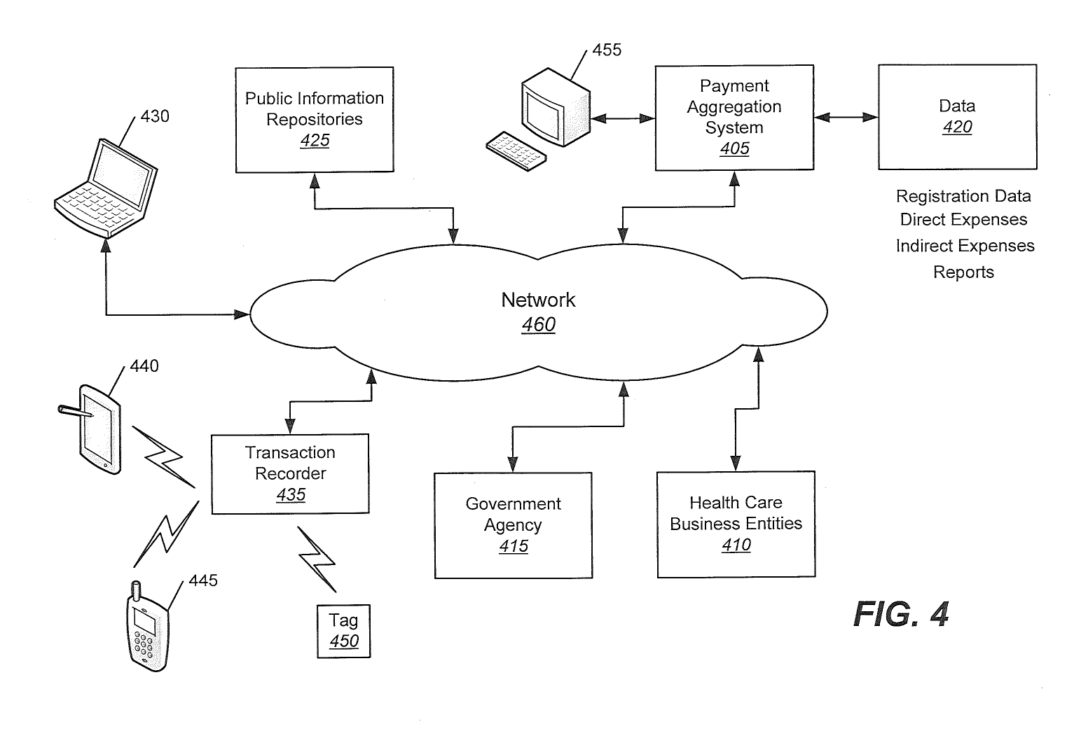

FIG. 4 is a block diagram that illustrates a system for managing the transfer of value between a health care business entity and an HCP according to some embodiments of the inventive subject matter. The system comprises a payment aggregation system 405 that may be configured to collect transfer of value transactions between a health care business entity 410 and an HCP, process those transactions, and report them to a governmental regulatory agency 415, the health care business entity 410, and/or the HCP. The payment aggregation system 405 may store the data and/or information used in aggregating transfer of value transactions for an HCP in a data repository 420. The data repository 420 may store data and/or information, such as, but not limited to, registration data for HCPs associated with various events, such as meetings, conferences, and the like, sponsored by various health care business entities 410. The data repository 420 may also store data and/or information regarding the direct expenses and the indirect expenses incurred by health care business entities through transactions with HCPs, who are the recipients of transfers of value resulting from these transactions. The payment aggregation system 405 may also generate reports that are compliant with a formatting standard established by a governmental regulatory agency, such as the DHHS, to provide the transfer of value information resulting from transactions between a health care business entity 410 and an HCP to the governmental regulatory agency. Other types of reports may also be generated, such as reports that are formatted in accordance with requests from health care business entities 410 and/or HCPs.

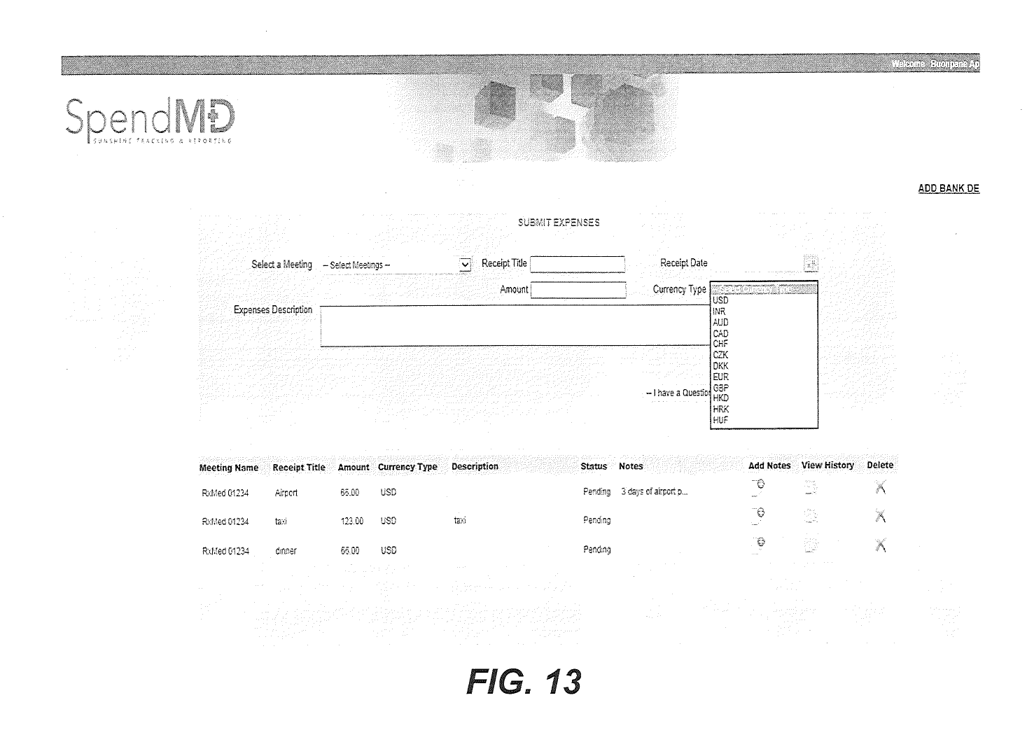

The data 420 collected by the payment aggregation system 405 may come from a variety of sources. One source of information is public information repositories 425. These may be government databases from which transfer of value data and/or information between health care business entities 410 and HCPs has been reported previously and is publicly available. For example, transfer of value data and/or information may have been reported to a state agency, which can be uploaded for reporting to a federal government agency, such as the DHHS. The public information repositories 425 may also represent public sources of information for expenses provided by third parties, such as transportation expenses, food and beverage expenses, lodging expenses, and the like. These data may be uploaded and associated with various transactions that are part of an event sponsored by a health care business entity 410, for example. Another source of data 420 collected by the payment aggregation system 405 may be manually entered as represented by computer 430. For example, an HCP or an organization for which an HCP works may manually report transactions involving a transfer of value from a health care business entity 410 to the HCP. An HCP, for example, may log in to the payment aggregation system 405 and provide receipts, confirmation documents, a description of a transaction with a health care business entity 410. FIG. 13 illustrates an example interface for manual entry of transactions according to some embodiments of the inventive subject matter. The health care business entities 410 may be another source of data 420 collected by the payment aggregation system 405. For example, a health care business entity 410 may upload transfer of value data and/or information regarding direct and/or indirect expenses incurred for an HCP. In the case of some indirect expenses, the health care business entity 410 may, for example, upload the cost of certain transactions, such as meals, entertainment, and the like. When the HCP is determined to have accepted such a transaction involving an indirect expense, e.g., attended a meal, then the transfer of value associated with the transaction can be attributed to the HCP for reporting.

According to some embodiments of the inventive subject matter, a transaction recorder 435 may be used to generate a recording of an acceptance of a transfer of value by an HCP during a transaction. For example, the transaction recorder may scan a code, such as a barcode or QR code provided by an HCP through a device, such as mobile devices 440 or 445 or even through a pre-printed label that identifies the HCP by name and/or National Provider Identifier (NPI) for example. The transaction recorder may, for example, be a mobile device having an application thereon that is configured to obtain the HCP identification information, which can then be reported to the payment aggregation system 405. The transaction recorder 435 can provide an electronic record that an HCP engaged in a transaction with a health care business entity 410 that involved the transfer of value to the HCP. For example, the transaction recorder 435 may be used at the entrance to a dining room where a meal is to be provided to various HCPs in attendance at a meeting. To gain entry to the dining room, the HCP is required to be processed using the transaction recorder 435 to obtain the identity of the HCP. The transaction recorder 435 may be embodied in various ways to obtain the identity of an HCP in accordance with different embodiments of the inventive subject matter. For example, the transaction recorder 435 may be configured to use near field communication (NFC), such as Bluetooth, Wi-Fi, or the like, to obtain HCP identification. In other embodiments, an HCP may have an RFID tag 450 that can be read by the transaction recorder 435 to obtain the HCP identification. In still other embodiments, the transaction recorder 435 may involve a registrar typing an identification, which may be a name and/or NPI, of the HCP into an application for transmission to the payment aggregation system 405 before granting the HCP access to the event involving the transfer of value, which may, for example, be a meal, a gift, a hotel room key, etc. The transaction recorder 435 may report electronic records of HCP transactions with a health care business entity 410 back to the payment aggregation system 405 for storage in the data repository 420 in real time. By transmitting the HCP transaction information back to the data aggregation system 405 immediately, the risk of losing the transaction information or the transaction information being corrupted can be reduced as compared to storing it locally on personal computers, laptops, mobile devices, or the like.

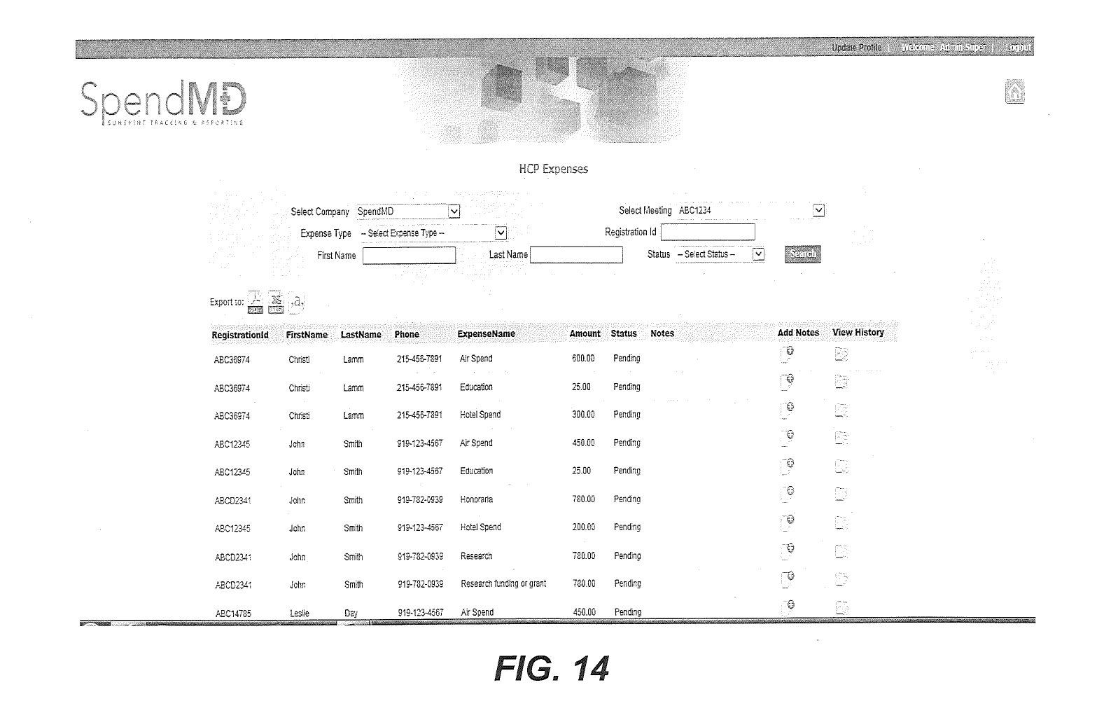

Various entities may access the payment aggregation system 405 to perform queries on the data 420 collected by the payment aggregation system 405. For example, an administrator 455 associated with the payment aggregation system 405 may have full permissions to examine and/or perform queries on the data 420. A health care business entity 410 may be able to perform queries and request reports for all HCPs associated with any event sponsored by the health care business entity 410. An HCP may be able to request a report and/or perform queries on all transactions associated with the HCP by way of the computer 430, for example. FIG. 14 illustrates a user interface that allows a user to query based on a particular meeting identifier to review transfer of value information for healthcare professional attendees to the meeting

The payment aggregation system 405, health care business entities 410, government agency(s) 415, public information repositories 425, computer 430, and transaction recorder 435 may be coupled to one another via a network 460. The network 460 may be a global network, such as the Internet or other publicly accessible network. Various elements of the network 460 may be interconnected by a wide area network, a local area network, an Intranet, and/or other private network, which may not be accessible by the general public. Thus, the communication network 460 may represent a combination of public and private networks or a virtual private network (VPN). The network 460 may be a wireless network, a wireline network, or may be a combination of both wireless and wireline networks.

Although FIG. 4 illustrates an exemplary communication network and an exemplary hardware/software architecture that may be used to manage the transfer of value between a health care business entity and an HCP, it will be understood that embodiments of the present invention are not limited to such a configuration but are intended to encompass any configuration capable of carrying out operations as described herein.

Computer program code for carrying out operations of data processing systems and servers described above with respect to FIG. 4, such as the payment aggregation system 405, may be written in a high-level programming language, such as Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. Embodiments described herein, however, are not limited to any particular programming language. It will be further appreciated that the functionality of any or all of the program modules may also be implemented using discrete hardware components, one or more application specific integrated circuits (ASICs), or a programmed digital signal processor or microcontroller.

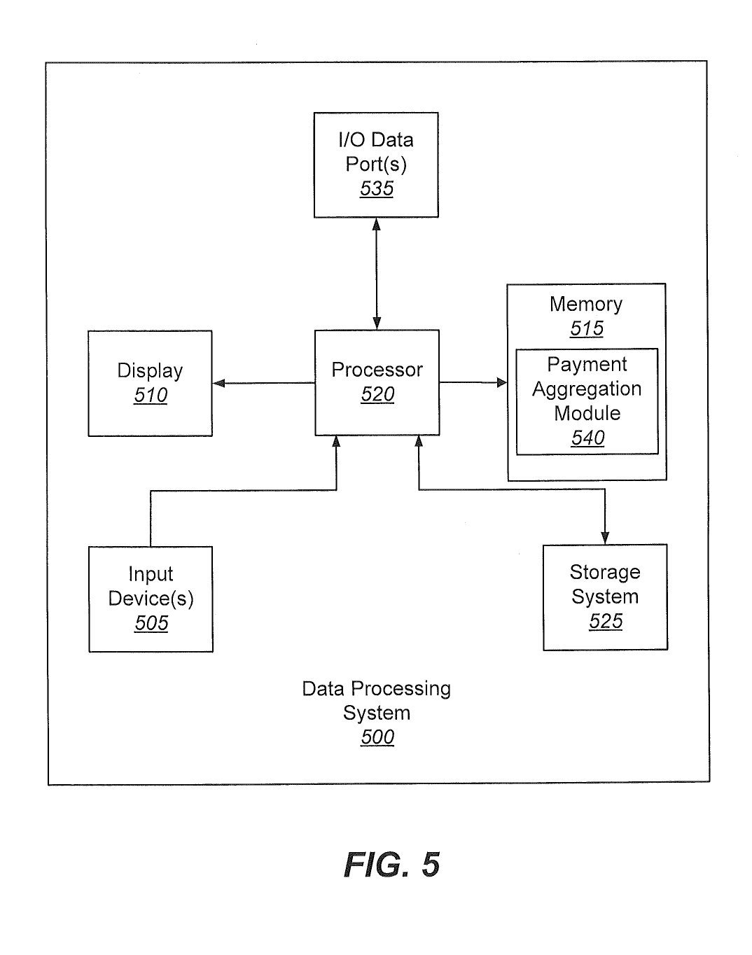

FIG. 5 illustrates a data processing system 500 that may be used in embodiments of the payment aggregation system 405 in accordance with some embodiments of the inventive subject matter. The data processing system 500 comprises input device(s) 505, such as a keyboard or keypad, a display 510, and a memory 515 that communicate with a processor 520. The data processing system 500 may further comprise a storage system 525, and an I/O data port(s) 535 that also communicate with the processor 520. The storage system 525 may include removable and/or fixed media, such as floppy disks, ZIP drives, hard disks, or the like as well as virtual storage such as a RAMDISK. The I/O data port(s) 535 may be used to transfer information between the data processing system 500 and another computer system or a network (e.g., the Internet). These components may be conventional components, such as those used in many conventional computing devices, and their functionality, with respect to conventional operations, is generally known to those skilled in the art. The memory 515 may be configured with a payment aggregation module module 540 that may be used to manage the transfer of value between a health care business entity and an HCP according to some embodiments of the inventive subject matter.

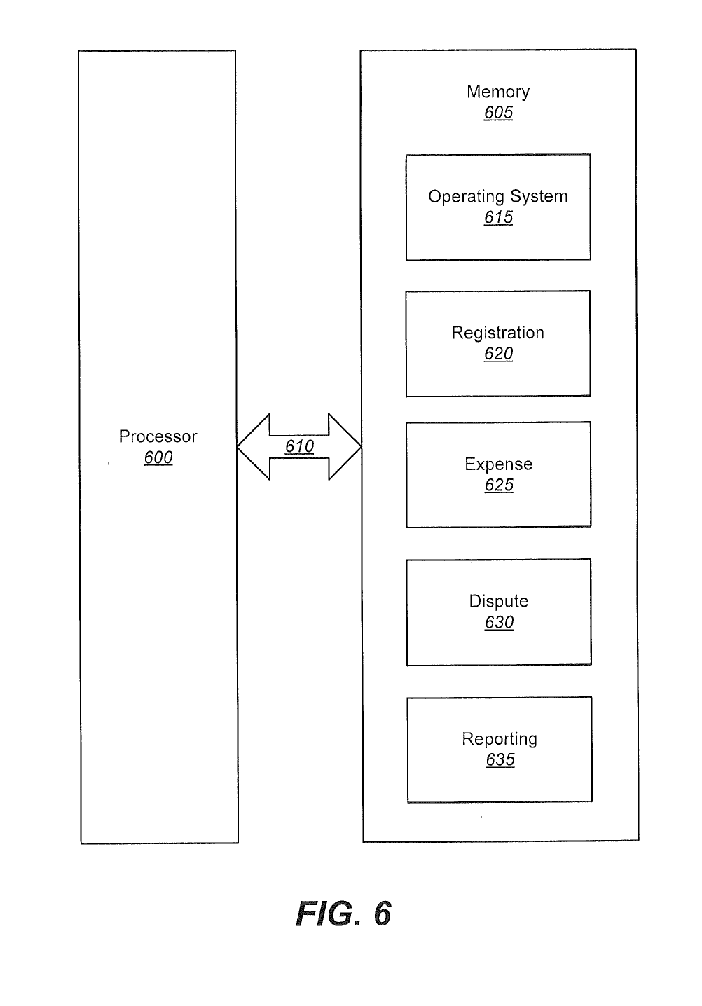

FIG. 6 illustrates a processor 600 and memory 605 that may be used in embodiments of data processing systems, such as the data processing system 500 of FIG. 5, for managing the transfer of value between a health care business entity and an HCP in accordance with some embodiments of the inventive subject matter. The processor 600 communicates with the memory 605 via an address/data bus 610. The processor 600 may be, for example, a commercially available or custom microprocessor. The memory 605 is representative of the one or more memory devices containing the software and data used to provision software in accordance with some embodiments of the present invention. The memory 605 may include, but is not limited to, the following types of devices: cache, ROM, PROM, EPROM, EEPROM, flash, SRAM, and DRAM.

As shown in FIG. 6, the memory 605 may contain up to five or more categories of software and/or data: an operating system 615, a registration module 620, an expense module 625, a dispute module 630, and a reporting module 635. The operating system 615 generally controls the operation of the data processing system. In particular, the operating system 615 may manage the data processing system's software and/or hardware resources and may coordinate execution of programs by the processor 600.

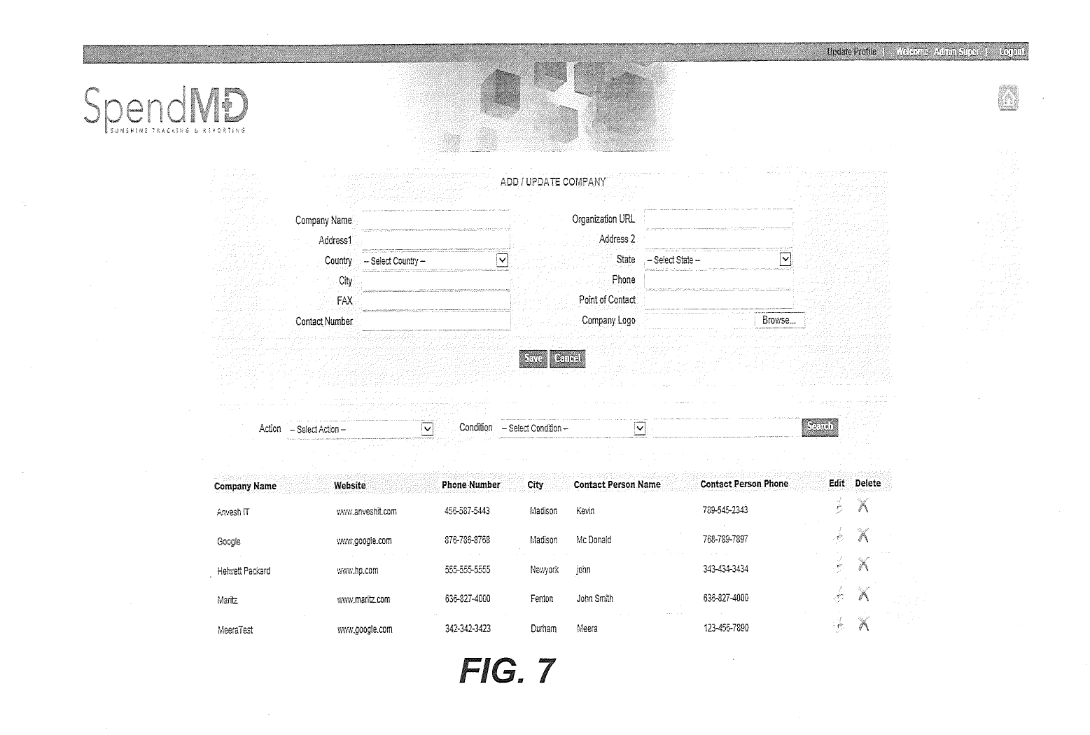

The registration module 620 module may be configured to register the identifications of various HCPs with the payment aggregation system 405 by name and/or NPI. The HCPs may also provide data or information, such as phone number, home/work address, email address, and the like. The registration module 405 may also be configured to register health care business entities 410. As shown in FIG. 7, the registration module 620 may provide a screen through which a health care business entity may provide various identifying information including name, address, contact person, and phone number. Registration information for HCPs and/or health care business entities 410 may also be provided to the payment aggregation system 405 through bulk data uploads.

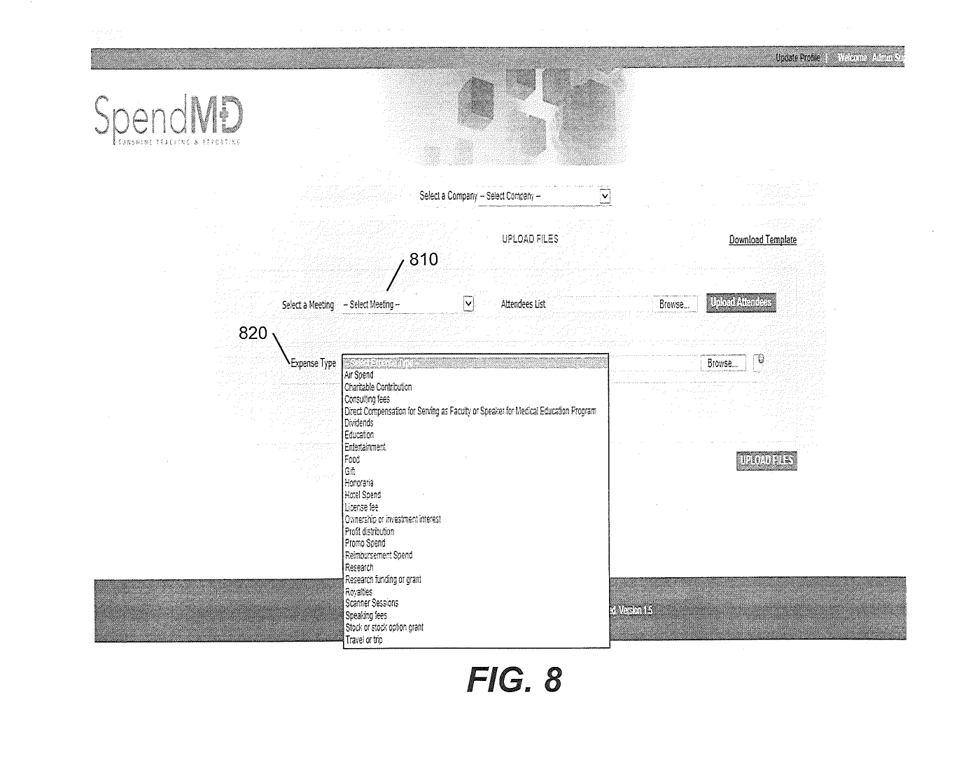

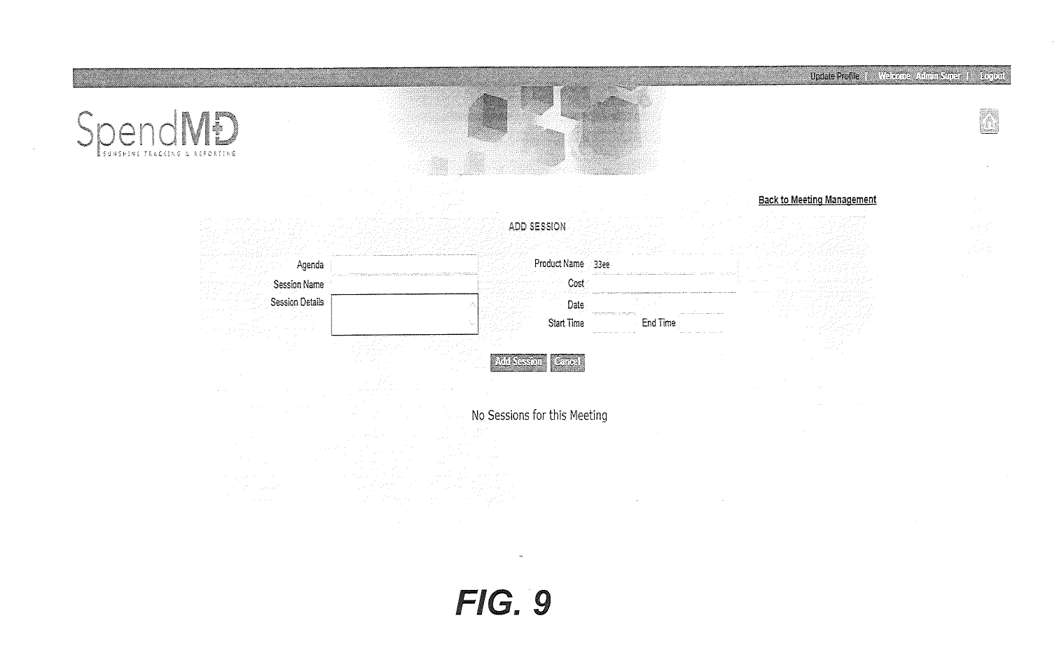

The expense module 625 may be configured to collect and store data and/or information regarding the direct expenses and the indirect expenses incurred by health care business entities through transactions with HCPs, who are the recipients of transfers of value resulting from these transactions. As shown in FIG. 8, the expense module 625 may be configured to upload data from a health care business entity 410 for a particular event 810. Data and/or information associated with specific types of transactions 810, e.g., gifts, food, etc. may be uploaded. As described above, in addition to uploading bulk data and/or information associated with transactions involving the transfer of value from a health care business entity 410 to an HCP, the transaction recorder 435 may electronically generate a recordation of when an HCP accepts a transfer of value from a health care business entity 410 and communicate the recordation of the acceptance by the HCP to the payment aggregation system 405 where it can be saved in the data repository 420. For example, as shown in FIG. 9, a health care business entity may define various transaction opportunities, which may be called sessions for an event such as a conference. In the example shown in FIG. 9, various transaction opportunities can be defined as sessions, which may include a dinner, afternoon session, lunch, general session, and registration, which have various costs associated therewith. The transaction recorder 435 may be used to electronically generate a recordation of the attendance of an HCP at these various sessions, which constitutes the acceptance of the transfer of value, i.e. cost, by the HCP. A timestamp and, in some embodiments, a signature of the HCP may be included in the recordation, which may provide reliable evidence that the HCP received value from the health care business entity.

The dispute module 630 be configured to communicate the various transactions in which value has been transferred to the HCP to the HCP to provide the HCP with an opportunity with a time period to dispute the transactions or confirm the transactions before the transactions are reported to a governmental regulatory agency, such as the DHHS. Certain governmental jurisdictions may provide a second defined time period within which an HCP can dispute a transfer of value from a health care business entity 410 that has been attributed to the HCP after the transfer of value is reported to the governmental agency. The time period for the PPSA or Open Payments is 45 days.

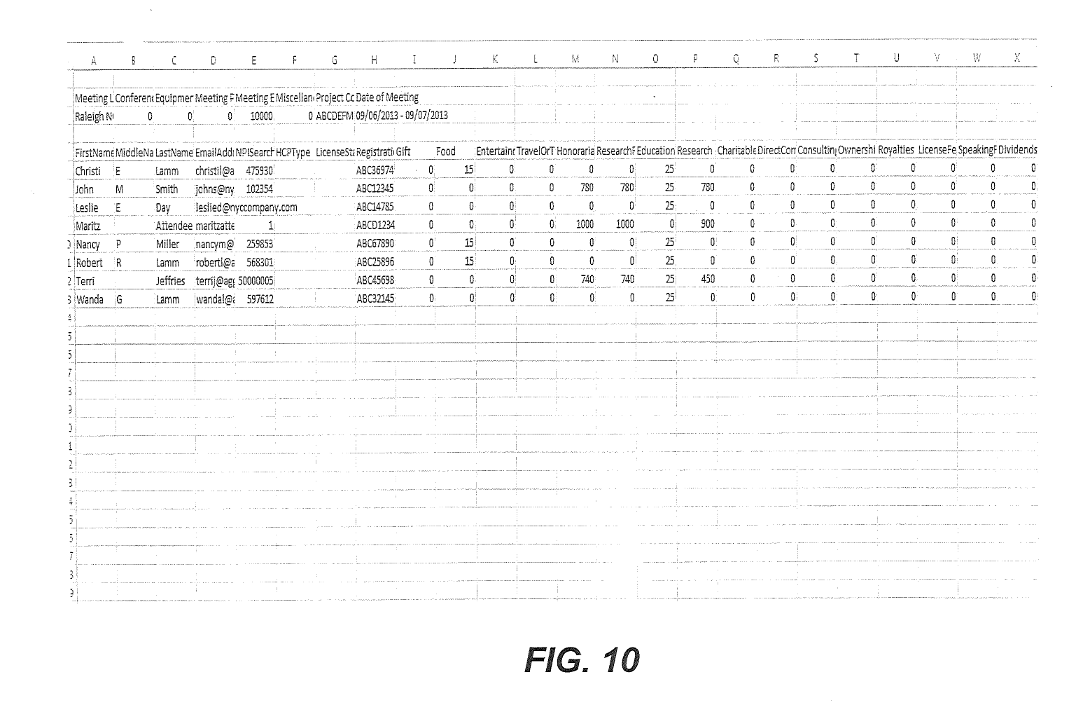

The reporting module 635 may be configured to generate reports that are compliant with a formatting standard established by a governmental regulatory agency 415, such as the DHHS, to provide the transfer of value information resulting from transactions between a health care business entity 410 and an HCP to the governmental regulatory agency 415. Such reports may be submitted back to the health care business entity 410 for submission to the governmental regulatory agency 415 or the reports may be submitted directly to the governmental regulatory agency 415 on behalf of the health care business entity 410 in accordance with various embodiments of the inventive subject matter. Other types of reports may also be generated, such as reports that are formatted in accordance with requests from health care business entities 410 and/or HCPs. FIG. 10 illustrates an example report in which various HCP attendees to a conference sponsored by a health care business entity are identified along with the transfer of value ascribed to each HCP based on transactions pertaining to meals, honoraria, and other categories.

Although FIG. 6 illustrates exemplary hardware/software architectures that may be used in data processing systems, such as the data processing system 500 of FIG. 5, for managing the transfer of value between a health care business entity and an HCP, it will be understood that the present invention is not limited to such a configuration but is intended to encompass any configuration capable of carrying out operations described herein. Moreover, the functionality of the payment aggregation system 405 of FIG. 4, data processing system 500 of FIG. 5, and the hardware/software architecture of FIG. 6 may be implemented as a single processor system, a multi-processor system, a multi-core processor system, a network of stand-alone computer systems, or one or more virtual machines in the cloud in accordance with various embodiments.

Computer program code for carrying out operations of data processing systems discussed above with respect to FIG. 6 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. Embodiments described herein, however, are not limited to any particular programming language. It will be further appreciated that the functionality of any or all of the program modules may also be implemented using discrete hardware components, one or more application specific integrated circuits (ASICs), or a programmed digital signal processor or microcontroller.

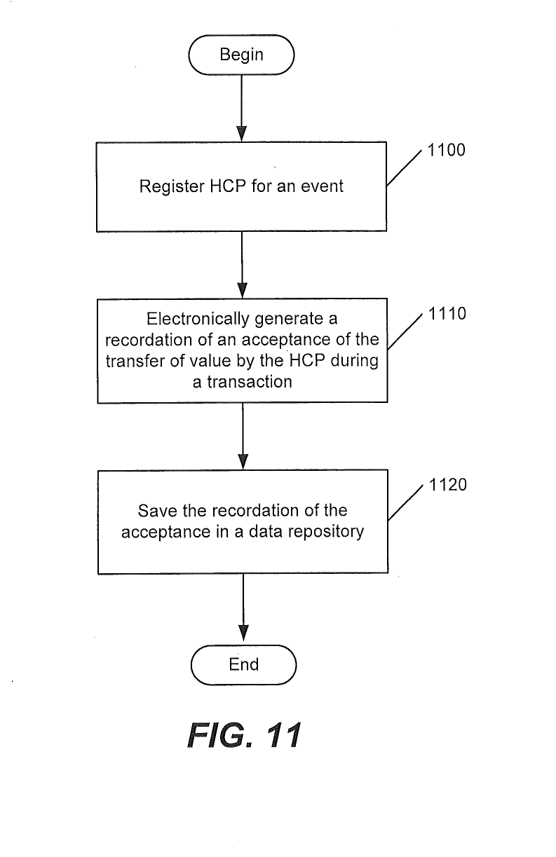

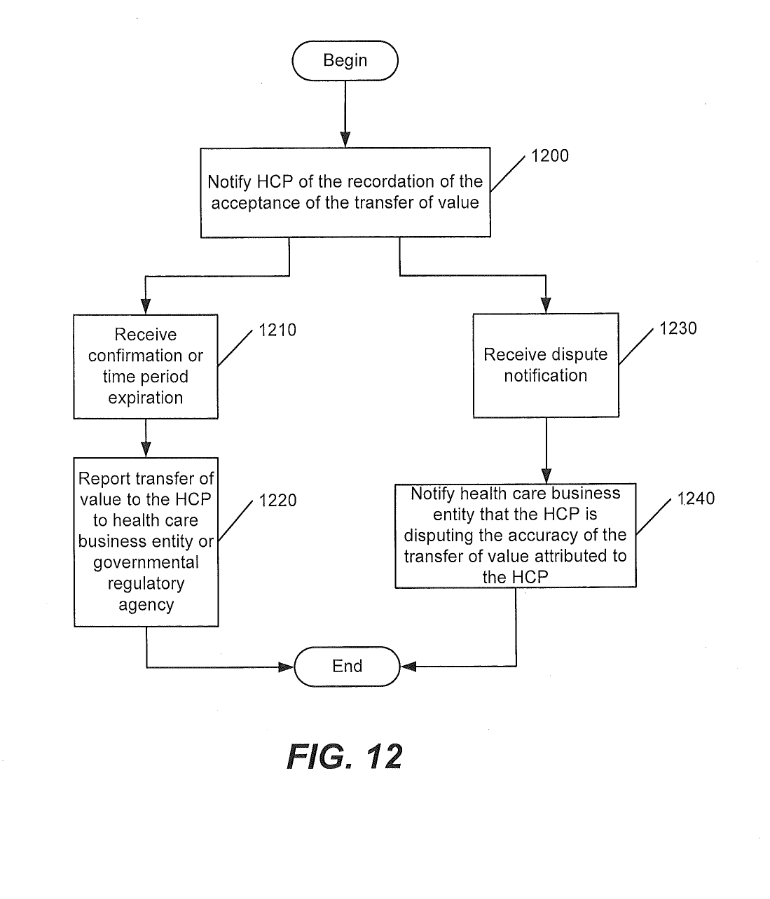

FIGS. 11 and 12 are flowcharts that illustrate operations for managing the transfer of value between a health care business entity and an HCP according to some embodiments of the inventive subject matter. Referring now to FIG. 11, operations begin at block 1100 where an HCP is registered for an event. At block 1110, the transaction recorder 435 may electronically generate a recordation of an acceptance of the transfer of value by the HCP during a transaction. For example, the transaction recorder 435 may obtain the name and/or NPI of an HCP upon entrance to a dinner, upon acceptance of a gift, when checking in to a hotel room, or other type of transaction involving the transfer of value to the HCP. The recordation generated by the transaction recorder 435 at block 1110 may be communicated to the payment aggregation system 405 at block 1120 where it is stored in the data repository 420. The recordation of the acceptance of the transfer of value by the HCP may be aggregated with other transactions involving the HCP based on data and/or information obtained from various sources as described above, compiled into a report, and submitted back to the health care business entity 410 for submission to a governmental regulatory agency 415, such as the DHHS, to comply with one or more government laws and/or regulations. In other embodiments, the report may be submitted directly to the governmental regulatory agency 415 on behalf of the health care business entity 410 in accordance with various embodiments of the inventive subject matter. The payment aggregation system 405 may generate reports in various formats so as to be accepted by various parties, including various government agencies 415, health care business entities 410, and/or HCPs.

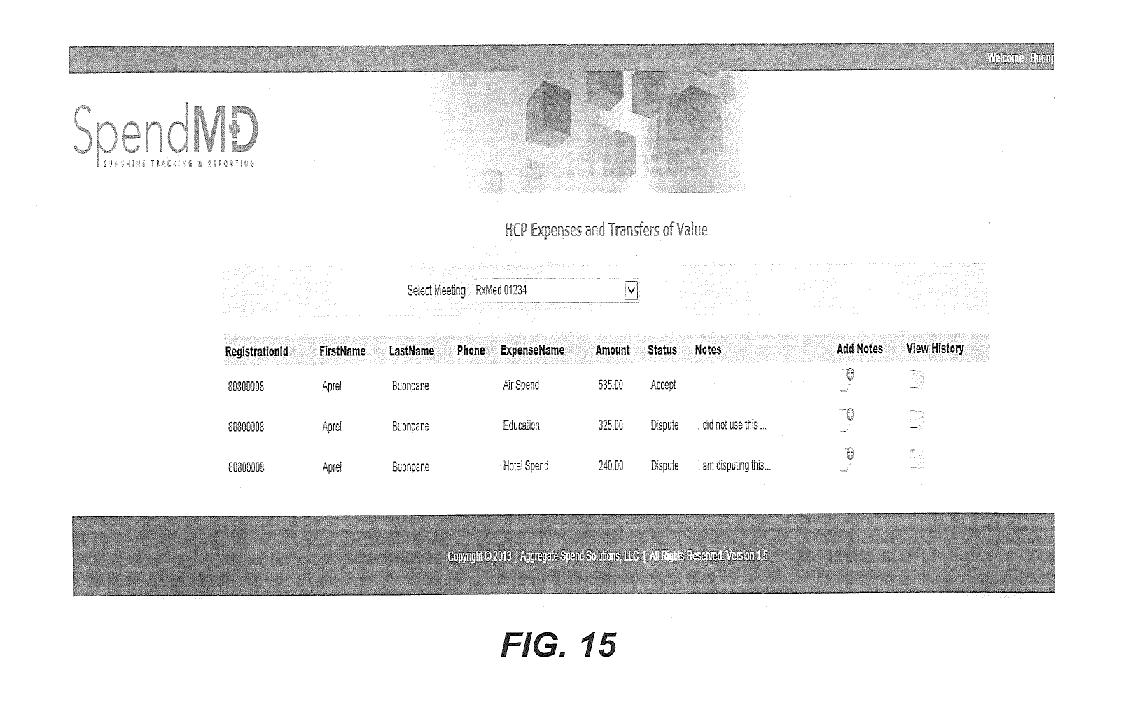

Referring now to FIG. 12, the payment aggregation system 405 may notify an HCP at block 1200 when there has been the recordation of the HCP having accepted a transfer of value from a health care business entity 410. The notification may include a time period after which the health care business entity 410 or the payment aggregation system 405 (or some other proxy for the health care business entity 410) may report the transfer of value to the HCP to a governmental regulatory agency 415. Once confirmation has been received of the period for dispute has lapsed, the transfer of value to the HCP may be reported to a governmental regulatory agency 415 at block 1220. If the HCP chooses to dispute the transfer of value attributed to the HCP, then the payment aggregation system 405 may receive a dispute notification at block 1230. At block 1240, the payment aggregation system 405 may notify the health care business entity 410 who is attributing a transfer of value to the HCP that the HCP is disputing the transfer of value allowing the health care business entity 410 to share the records used as a basis for the attribution of the transfer of value with the HCP. As shown in FIG. 15, when reviewing the transfer of value transactions attributed to a particular HCP for a particular meeting, for example, the payment aggregation system 405 shows that some of the transactions are being disputed by the HCP. With many governmental regulatory agencies 415, an HCP is given a time period during which the HCP can dispute a transfer of value that has been reported to the governmental regulatory agency 415. But by resolving disputes with an HCP in advance of reporting to the governmental regulatory agency 415, a health care business entity 410 may reduce the risk of being audited due to faulty record keeping. A governmental regulatory agency 415 may be more likely to audit health care business entities 410 for which HCPs frequently dispute reports of transfer of value.

The flowcharts and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

That which is claimed:

1. A method, comprising:
performing operations as follows on at least one processor:
associating a health care professional (HCP) with an event, the event comprising a transaction involving a transfer of value from an entity to the HCP;
electronically generating a recordation of an acceptance of the transfer of value by the HCP during the transaction; and
saving the recordation of the acceptance of the transfer of value in a data repository.

2. The method of claim 1, wherein electronically generating the recordation of the acceptance comprises:
scanning a code that identifies the HCP.

3. The method of claim 2, wherein the code is a barcode.

4. The method of claim 2, wherein the code is a Quick Response (QR) code.

5. The method of claim 1, wherein electronically generating the recordation of the acceptance comprises:
detecting a mobile device associated with the HCP using a near field communication (NFC) connection.

6. The method of claim 1, wherein electronically generating the recordation of the acceptance comprises:
detecting a radio frequency identification (RFID) tag associated with the HCP using an RFID tag reader.

7. The method of claim 1, wherein saving the recordation of the acceptance of the transfer of value comprises:
formatting the recordation of the acceptance of the transfer of value into a report that is compliant with a formatting standard established by a governmental regulatory agency.

8. The method of claim 1, further comprising:
notifying the HCP of the recordation of the acceptance of the transfer of value.

9. The method of claim 8, further comprising:
receiving a confirmation from the HCP that the recordation of the acceptance of the transfer of value is accurate;
formatting the recordation of the acceptance of the transfer of value into a report that is compliant with a formatting standard established by a governmental regulatory agency; and
submitting the report to the entity and/or the governmental agency.

10. The method of claim 8, further comprising:
receiving a dispute notification from the HCP indicating that the recordation of the acceptance of the transfer of value is inaccurate; and
notifying the entity that the HCP is disputing the accuracy of the recordation of the acceptance of the transfer of value.

11. The method of claim 8, further comprising:
formatting the recordation of the acceptance of the transfer of value into a report that is compliant with a formatting standard established by a governmental regulatory agency; and
submitting the report to the entity and/or the governmental regulatory agency when no response is received from the HCP disputing the recordation of the acceptance of the transfer of value within a defined time period.

12. The method of claim 1, wherein saving the recordation of the acceptance of the transfer of value comprises:
aggregating the recordation of the acceptance of the transfer of value with recordations of a plurality of transactions involving transfers of value from the entity to the HCP; and
wherein the method further comprises:
formatting the recordations that have been aggregated into a report that is compliant with a formatting standard established by a governmental regulatory agency; and
submitting the report to the entity and/or the governmental regulatory agency.

13. The method of claim 1, wherein saving the recordation of the acceptance of the transfer of value comprises:
transmitting the recordation of the acceptance of value to the data repository in real time.

14. A system, comprising:
at least one processor; and
a memory coupled to the at least one processor and comprising computer readable program code embodied in the memory that when executed by the at least one processor causes the at least one processor to perform operations comprising:
associating a health care professional (HCP) with an event, the event comprising a transaction involving a transfer of value from an entity to the HCP;
electronically generating a recordation of an acceptance of the transfer of value by the HCP during the transaction; and
saving the recordation of the acceptance of the transfer of value in a data repository.

15. The system of claim 14, wherein electronically generating the recordation of the acceptance comprises:
scanning a code that identifies the HCP.

16. The system of claim 15, wherein the code is a barcode.

17. The system of claim 15, wherein the code is a Quick Response (QR) code.

18. The system of claim 14, wherein electronically generating the recordation of the acceptance comprises:
detecting a mobile device associated with the HCP using a near field communication (NFC) connection.

19. The system of claim 14, wherein electronically generating the recordation of the acceptance comprises:
detecting a radio frequency identification (RFID) tag associated with the HCP using an RFID tag reader.

20. The system of claim 14, wherein saving the recordation of the acceptance of the transfer of value comprises:
formatting the recordation of the acceptance of the transfer of value into a report that is compliant with a formatting standard established by a governmental regulatory agency.

21. The system of claim 14, wherein the operations further comprise:
notifying the HCP of the recordation of the acceptance of the transfer of value.

22. The system of claim 21, wherein the operations further comprise:
receiving a confirmation from the HCP that the recordation of the acceptance of the transfer of value is accurate;
formatting the recordation of the acceptance of the transfer of value into a report that is compliant with a formatting standard established by a governmental regulatory agency; and
submitting the report to the entity and/or the governmental regulatory agency.

23. The system of claim 21, wherein the operations further comprise:
receiving a dispute notification from the HCP indicating that the recordation of the acceptance of the transfer of value is inaccurate; and
notifying the entity that the HCP is disputing the accuracy of the recordation of the acceptance of the transfer of value.

24. The system of claim 21, wherein the operations further comprise:
formatting the recordation of the acceptance of the transfer of value into a report that is compliant with a formatting standard established by a governmental regulatory agency; and
submitting the report to the entity and/or the governmental regulatory agency when no response is received from the HCP disputing the recordation of the acceptance of the transfer of value within a defined time period.

25. The system of claim 14, wherein saving the recordation of the acceptance of the transfer of value comprises:
aggregating the recordation of the acceptance of the transfer of value with recordations of a plurality of transactions involving transfers of value from the entity to the HCP; and
wherein the operations further comprise:
formatting the recordations that have been aggregated into a report that is compliant with a formatting standard established by a governmental regulatory agency; and
submitting the report to the entity and/or the governmental regulatory agency.

26. The system of claim 14, wherein saving the recordation of the acceptance of the transfer of value comprises:
transmitting the recordation of the acceptance of value to the data repository in real time.

27. A computer program product, comprising:
a tangible computer readable storage medium comprising computer readable program code embodied in the medium that when executed by a processor causes the processor to perform operations comprising:
associating a health care professional (HCP) with an event, the event comprising a transaction involving a transfer of value from an entity to the HCP;
electronically generating a recordation of an acceptance of the transfer of value by the HCP during the transaction; and
saving the recordation of the acceptance of the transfer of value in a data repository.

28. The computer program product of claim 27, wherein electronically generating the recordation of the acceptance comprises:
scanning a code that identifies the HCP.

29. The computer program product of claim 28, wherein the code is a barcode.

30. The computer program product of claim 28, wherein the code is a Quick Response (QR) code.

31. The computer program product of claim 27, wherein electronically generating the recordation of the acceptance comprises:
detecting a mobile device associated with the HCP using a near field communication (NFC) connection.

32. The computer program product of claim 27, wherein electronically generating the recordation of the acceptance comprises:
detecting a radio frequency identification (RFID) tag associated with the HCP using an RFID tag reader.

33. The computer program product of claim 27, wherein saving the recordation of the acceptance of the transfer of value comprises:
formatting the recordation of the acceptance of the transfer of value into a report that is compliant with a formatting standard established by a governmental regulatory agency.

34. The computer program product of claim 27, wherein the operations further comprise:
notifying the HCP of the recordation of the acceptance of the transfer of value.

35. The computer program product of claim 34, wherein the operations further comprise:
receiving a confirmation from the HCP that the recordation of the acceptance of the transfer of value is accurate;
formatting the recordation of the acceptance of the transfer of value into a report that is compliant with a formatting standard established by a governmental regulatory agency; and
submitting the report to the entity and/or the governmental regulatory agency.

36. The computer program product of claim 34, wherein the operations further comprise:
receiving a dispute notification from the HCP indicating that the recordation of the acceptance of the transfer of value is inaccurate; and
notifying the entity that the HCP is disputing the accuracy of the recordation of the acceptance of the transfer of value.

37. The computer program product of claim 34, wherein the operations further comprise:
formatting the recordation of the acceptance of the transfer of value into a report that is compliant with a formatting standard established by a governmental regulatory agency; and
submitting the report to the entity and/or the governmental regulatory agency when no response is received from the HCP disputing the recordation of the acceptance of the transfer of value within a defined time period.

38. The computer program product of claim 27, wherein saving the recordation of the acceptance of the transfer of value comprises:
aggregating the recordation of the acceptance of the transfer of value with recordations of a plurality of transactions involving transfers of value from the entity to the HCP; and
wherein the operations further comprise:
formatting the recordations that have been aggregated into a report that is compliant with a formatting standard established by a governmental regulatory agency; and
submitting the report to the entity and/or the governmental regulatory agency.

39. The computer program product of claim 27, wherein saving the recordation of the acceptance of the transfer of value comprises:
transmitting the recordation of the acceptance of value to the data repository in real time.
